(19) United States
(12) Patent Application Publication
(10) Pub. No.: US 2014/0325346 A1
(43) Pub. Date: Oct. 30, 2014

(54) Shortened Network Address Linking to Image Representation of Web Page

(71) Applicants: Jerry J. Liu, Cupertino, CA (US); Jun Xiao, Austin, TX (US); Xiao-Wei Wu, Shanghai (CN); Hua Zhang, Shanghai (CN)

(72) Inventors: Jerry J. Liu, Cupertino, CA (US); Jun Xiao, Austin, TX (US); Xiao-Wei Wu, Shanghai (CN); Hua Zhang, Shanghai (CN)

(21) Appl. No.: 14/347,380

(22) PCT Filed: Jan. 20, 2012
(86) PCT No.: PCT/CN2012/070642

§ 371 Date: Mar. 26, 2014

(51) Int. Cl. G06F 17/30; H04L 29/08; G06F 3/0484; H04L 29/12

(52) U.S. Cl. CPC G06F 17/30905; H04L 61/6013; H04L 67/02; G06F 3/04842
USPC 715/238

(57) ABSTRACT

An image representation (204) of a portion of a web page (202) accessible at a network address is generated as one or more image files (226). The image representation is accessible at a shortened network address.

### BACKGROUND

Traditionally users have viewed web pages of web sites via computers, including desktop computers and laptop or notebook computers. Although the screen sizes and screen resolutions and other characteristics of such computers can vary, designers of web pages can generally rely on there being a minimum specification for each of them when constructing web pages so that the web pages are optimally viewable on nearly any computer. However, more recently, users have begun to increasingly view web pages on other computing devices, including tablets and smartphones. These types of computing devices generally have minimum specifications of characteristics such as such resolution and screen size that are lower than those of computers.

### BRIEF DESCRIPTION OF THE DRAWINGS

FIG. 1 is a flowchart of an example method by which an image representation of a web page is accessible at a shortened network address.

FIG. 2 is a diagram depicting example generation of an image representation of a portion of a representative web page.

FIG. 3 is a diagram of an example architecture of an implementation including multiple client computing devices and a server computing system.

### DETAILED DESCRIPTION

As noted in the background section, users have begun to increasingly view web pages on computing devices, such as tablets and smartphones, other than computers like desktop and laptop or notebook computers. One issue for web designers is that the network addresses at which web pages are accessible, such as universal resource locator (URL) addresses, can be relatively long. For computing devices that have small or no physical keyboards, entry of these addresses on such devices is cumbersome.

A solution to this problem has been the use of network address shortening services. Such services receive as input a network address of a web page, and return a shortened network address that links to the same web page. Therefore, a user can share the shortened network address of a web page in lieu of the web page's original and typical much longer network address to permit other users to easily access the web page on their computing devices that have small or no physical keyboards.

However, this solution does not mitigate other problems with browsing web pages on computing devices like tablets and smartphones. In general, such computing devices have smaller-sized screens at lesser resolution than computer like desktop and laptop or notebook computers do. Further, such computing devices may have web browsing computer programs that cannot display certain types of content, such as actively and dynamically generated content like Flash content that use Adobe Flash software available from Adobe Systems Incorporated, of San Jose, Calif.

Furthermore, tablets, smartphone, and other such devices commonly communicate over wireless cellular connections, such as those that are considered the third generation (3G) and fourth generation (4G) mobile telecommunications. These types and other types of wireless communications usually have greater latency than other types of broadband communications like digital subscriber loop (DSL) communications and that afforded by cable modems. Latency can become an issue when what is generally thought of a web page is in actuality a collection of small files. Even if the speed of communication is relatively fast, if the latency is relatively high, the overall speed at which the web page is presented can be perceived as slow. This is because of the latency incurred between requesting each file of a web page and receiving the file. Stated another way, a single data file of a given size is transmitted more quickly than a number of smaller data files that in total have the same size.

A solution to these problems has been for web designers to develop two versions of a web site: one intended for display on computers, and another intended for display on more mobile devices like tablets and smartphones. This solution is less than ideal, however. At the very least, it is cumbersome, requiring web designers to develop two versions of the same web site, and many entities having web sites do not have the capabilities or the desire to maintain two versions of their web sites. To date, just a relatively small percentage of web sites have mobile counterparts.

The techniques disclosed herein provide for a novel way by which web pages and web sites can be accessed and viewed, such, as by using tablets and smartphones. A shortened network address corresponding to a web page that is normally accessible at a typically longer network address is generated. However, this shortened network address links to an image representation of a portion of the web page, such as the page's primary and most relevant content, and not the web page in its entirety. The image representation includes one or more image files and can represent a static version, in image form, of the text, images, and any actively and dynamically generated content of the web page.

Therefore, when a computing device accesses the web page at the shortened network address, the image files of the image representation of the portion of the web page instead are returned. The image representation that is returned to the computing device may itself be unique to the type of computing device that is requesting the web page at the shortened network address. For example, a smartphone having a smaller screen size and/or resolution and a slower processor and/or less memory may receive multiple image files of a first image representation of the web page.

By comparison, a tablet having a larger screen size and/or resolution and a faster processor and/or more memory may receive a single image file of a second, different image representation of the web page. The different image representations of the web pages take into account the different screen sizes and/or resolutions of these two computing devices. The image representation sent to the smartphone may be divided over multiple image files because the smartphone may have difficulty rendering a single, larger image file, whereas the tablet may have no such difficulty.

Furthermore, the image representation of a portion of the web page typically loads much more quickly than the web page itself. This is due to a number of reasons. First, the entire web page is not usually included in the image representation, but rather just a smaller portion thereof. Second, where the web page includes actively and dynamically generated content, like Flash content, an image representation of this content is usually smaller in size than the original version of content.

Third, even if the image representation is the same size or even larger in size than the corresponding portion of the web page, the image representation may still load more quickly than the web page itself. As noted above, a web page is typically a collection of small files, which becomes an issue when latency is relatively high. However, because the image representation is made up of a relatively small number of image files—and indeed, may be made up of just one image file—the impact of such relatively high latency is lessened. Instead of having to request and then wait for each of twenty files to be delivered, for example, a computing device just has to request and then wait for one image file to be delivered. The effects of latency are reduced by a factor equal to the ratio of the number of files that make up the web page divided by the number of image files that make up the image representation of a portion of this web page.

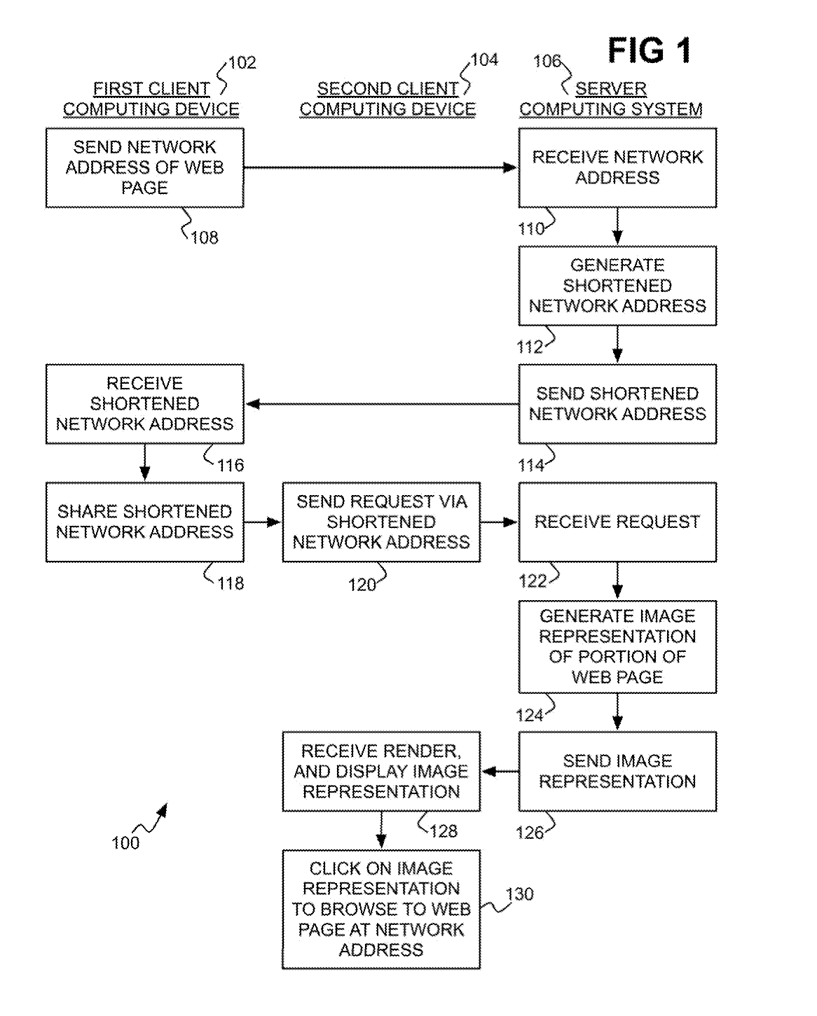

FIG. 1 shows an example method 100 of this general approach. The method 100 is divided over three columns that correspond the devices and the system that perform the method 100. A first client computing device 102 performs the parts of the method 100 in the left-hand column. A second client computing device 104 performs the parts of the method 100 in the center column. A server computing system 106 performs the parts of the method 100 in the right-hand column.

The client computing devices 102 and 104 may be the same or different computing device. Each of the client computing devices 102 and 104 may be a desktop, laptop, or notebook computer, a tablet, a smart phone, or another type of computing device. The server computing system 106 can include one or more server computing devices, and are interconnected to the client computing devices 102 and 104 over a network like the Internet.

The client computing device 102 sends a network address of a web page to the server computing system 106 (108), which receives the network address of the web page (110). In response, the server computing system 106 generates a shortened network address corresponding to the web page (112). However, the shortened network address does not link to the web page itself, in that the shortened network address does not link to or automatically forward to the network address of the web page.

The network address can be the UL address at which the web page is accessible over the network. The shortened network address can also be a URL address. The shortened network address is shorter in number of characters as compared to the network address. For instance, it is not uncommon for network addresses having lengths measuring in the mid-to-high tens of characters, whereas the shortened network address typically has less than ten characters.

The server computing system 106 returns the shortened network address to the first client computing device 102 (114), which receives the shortened network address (116). The first client computing device 102 can share the shortened network address with other computing devices like the second client computing device 104 (118). As noted above, the shortened network address corresponds to the web page and thus is for the web page; however, the shortened network address is not for the version of the actual web page accessible at the network address thereof that the first client computing device 102 sent to the server computing system 106 in part 108.

The second client computing device sends a request for the web page via the shortened network address to the server computing system 106 (120), which receives this request (122). In response, the server computing system 106 generates an image representation of a portion of the web page as retrieved at the network address thereof that the first client computing device 102 sent to the computing system 106 in part 108 (124). The image representation of the portion of the web page is generated as one or more image files, such as in JPG or in another image file format, and the portion can be the primary and most relevant portion of the web page.

The server computing system 106 can generate the image representation of the portion of the web page based on one or more characteristics of the client computing device 104 that sent the request via the shortened network address in part 120. These characteristics can include the physical screen size and/or the screen resolution of the client computing device 104, as well as the amount of memory and/or the processor type and/or speed of the computing device 104. For instance, the client computing device 104 may identify its general type or class of device as part of the request sent in part 120. For instance, in the hypertext transport protocol (HTTP), the client type is sent as part of an HTTP header. On this basis, the server computing system 106 may look up the characteristics of the client computing device 104.

The server computing system 106 may generate the image representation based on the characteristics of the client computing device 104 so that the portion of the web page is optimally displayed on and viewed at the computing device 104. For example, the screen size and/or the screen resolution may dictate how much of the web page is included in the portion in question, and may dictate the width and resolution of the image representation. A client computing device that has a larger screen size may have a correspondingly generated image representation that is larger in width, and a client computing device that has a larger resolution may have a correspondingly generated image representation is that is greater in resolution.

The amount of memory and/or the processor type and/or speed may dictate the number of image files that are generated. A client computing device that has less memory and/or a slower processor may not be able to efficiently render an image file that is relatively large in size. Therefore, for such a client computing device, the image representation is generated as more than one image file. By comparison, for a client computing device that has more memory and/or a faster processor, the image representation may be generated as just a single image file, because the client computing device may be able to efficiently render such a single file. The number of image files that are generated in this respect may be determined by judging the characteristics of the client computing device in accordance with a predetermined criterion, for instance.

In the example of FIG. 1, then, different image representations of the portion of the web page, potentially as different numbers of image files, may be generated for different client computing devices. This is the case even though the different client computing devices send requests via the same shortened network address. The different image representations correspond to the same web page, but may be of different portions of the web page. A client computing device that has poor graphics capability, for instance, may not receive the graphics or images as part of its image representation, whereas a client computing device that has better graphics capability may.

Different techniques may be employed both to identify the primary and most relevant portion of the web page, as well as to generate an image representation of the page as one or more image files. In one implementation, the techniques disclosed in the pending PCT patent application entitled “Determining similarity between elements of an electronic device,” filed on Jun. 30, 2010, and assigned application number PCT/CN2010/074813, are used for this portion identification and image representation generation. Other techniques may also be employed, however, to both identify the primary and most relevant portion of the web page, in accordance with a predetermined criterion, and then generate an image representation of the page.

The image representation of the portion of the web page can include just the one or more image files, and represents a static version in image form of the text, images, and any actively and dynamically generated content of this portion of the web page. The image representation is static in this respect because it may not change upon being displayed at a client computing device, whereas actively and dynamically content, such as Flash content, can. Although the original content of the web page is in the form of text, images, and any such actively and dynamically generated content, the image representation of the portion of the web page is thus just in image form. For example, in the case of text, rather than characters representing the letters of a word, the image representation is an image of the word itself.

The shortened network address is said to be linked to the image representation of the portion of the web page, because accessing the web page at the shortened network address causes the image representation to be returned for rendering and display as the one or more image files. However, in the example of FIG. 1 that has been described, the image representation is in actuality generated dynamically based on the characteristics of the client computing device 104. The image representation is generated responsive to receiving the request via the shortened network address from the client computing device 104, after the request has been received.

However, in other implementations, the server computing system 106 may statically generate the image representation prior to receiving the request from the client computing device 104. In these implementations, the server computing system 106 may generate one image representation that is sent to client computing devices that send requests via the shortened network address, regardless of the characteristics of these computing devices. As another example, the server computing system 106 may generate different image representations corresponding to different types of client computing devices that are expected to send requests via the shortened network address, prior to receiving such requests.

That is, in these and other implementations, part 124 may be performed prior to part 112 and/or part 114. The image representation of the portion of the web page in these implementations is thus generated prior to the shortened network address being sent back in part 114. When a request via the shortened network address is then received in part 122, the web page in question may be inspected again to determine if it has changed since the time the image representation was generated. If the web page has changed, then the image representation may be regenerated.

Furthermore, where part 124 is performed prior to part 112 and/or part 114, the image representation may be generated based on characteristics of the client computing device 102 where just one image representation is generated. When a request via the shortened network address is then received in part 122, in one implementation the image representation may not be regenerated if the underlying web page has not changed. However, in another implementation, the image representation may still be regenerated, even if the underlying web page has not changed, if the characteristics of the client computing device 104 differ from those of the client computing device 102 on which basis the image representation was first generated.

The server computing system 106 sends the image representation that has been generated to the client computing device 104 (126). That is, the computing system 106 transmits the one or more image files of this image representation. The client computing device 104 receives the image representation of the portion of the web page, and renders and displays the received image representation for viewing by a user at the client computing device 104 (128). Because the image representation has been generated based on the characteristics of the client computing device 104, the viewing experience of the web page via this image representation can advantageously be better than the viewing experience of the version of the web page at its original network address that the first client computing device 102 sent in part 108.

The image representation of the portion of the web page can, however, include an embedded link to the actual network address of the web page that the first client computing device 102 sent in part 108. As such, if a user clicks on any of the displayed image files of this image representation at the second client computing device 104, the client computing device 104 browses to the version of the web page at this network address (130). This ensures that the user is still able to view the original web page at its original network address if he or she desires.

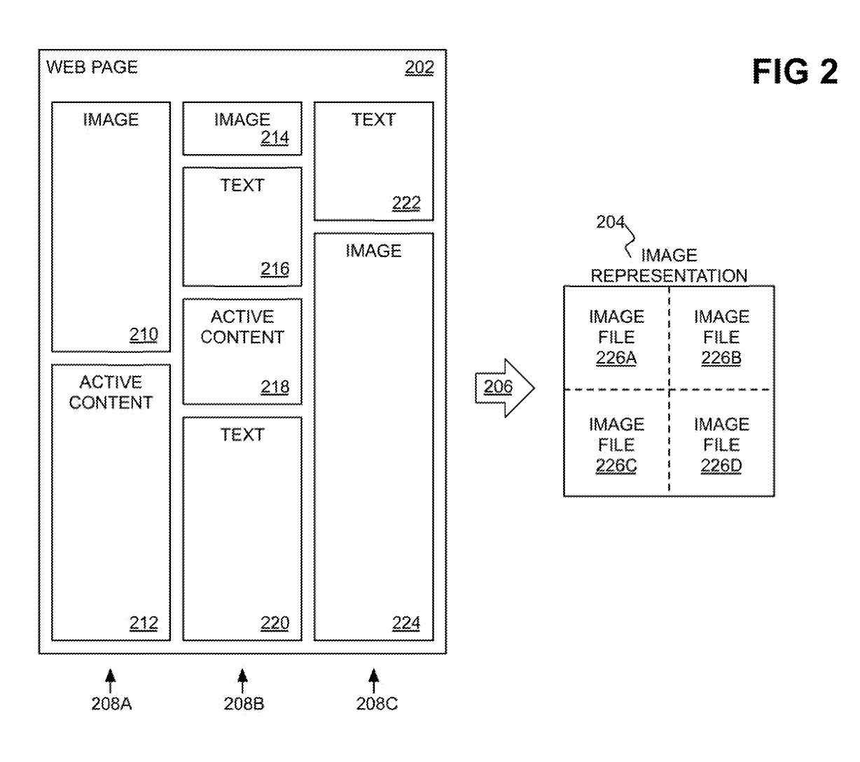

FIG. 2 shows example generation of an image representation 204 of a portion of a representative web page 202, as represented by the arrow 206. The web page 202 has content divided over three columns 208A, 208B, and 208C, which are collectively referred to as the columns 208. The column 208A includes an image 210 and active content 212. The column 208B includes an image 214, text 216, active content 218, and text 220. The active content 212 and 218 may be Flash content, for instance. The column 208C includes text 222 and an image 224.

The primary and most relevant portion of the web page 202 may be identified as the content within the column 208B. For example, it may be determined that the web page is of a news web site that typically displays a news story in the center column, and advertising and other information in the left and right columns. As such, the primary and most relevant portion of the web page 202 includes the image 214, the text 216, the active content 218, and the text 220 of the column 208B.

The image representation 204 thus in image form represents this primary and most relevant portion of the web page 202. The image representation 204 of the example of FIG. 2 includes four image files 226A, 226B, 226C, and 226D, collectively referred to as the image files 226. The image files 226 are displayed in a tiled manner as depicted in FIG. 2, so as to together form the image representation 204. A user viewing the image representation 204 may thus not be able to discern that the representation 204 includes four separate image files 226.

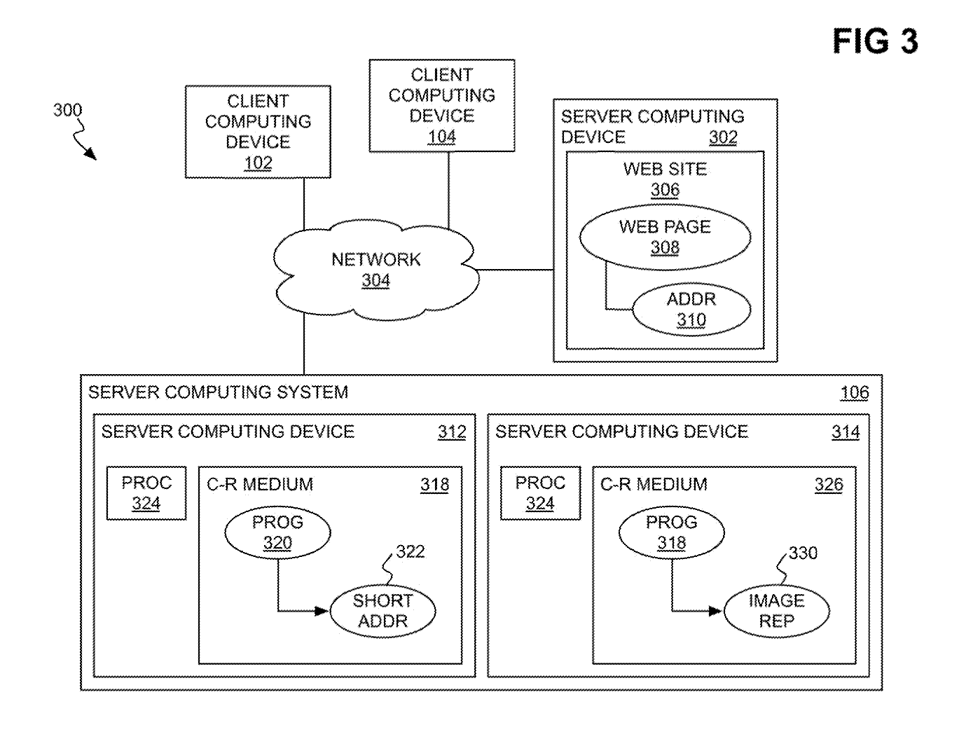

FIG. 3 shows an example architecture 300 by which the method 100 can be implemented. The architecture 300 includes the client computing devices 102 and 104, a server computing device 302, and the server computing system 106, which are communicatively interconnected via a network 304. The network 304 may be or include the Internet, an intranet, an extranet, a wired network, a wireless network, a cellular network, a telephony network, and so on. The client computing devices 102 and 104 may be the same computing device or different computing devices, as noted above. The client computing devices 102 and 104 may each be a desktop, laptop, or notebook computer, a smartphone, a tablet, or another type of computing device.

The sever computing device 302 hosts a web site 306 include a web page 308 that is accessible at a network address 310. Therefore, the client computing device 102 sends the network address 310 of the web page 308 to the server computing system 106 in the context of the method 100. The client computing devices 102 and 104, as well as the server computing system 106, are each able to access the web page 308 at the server computing device 302 via this network address 310.

The server computing system 106 includes or is implemented as a server computing device 312 and a server computing device 314 in the example of FIG. 3. However, in other implementations, the server computing system 106 may include or be implemented as just one server computing device, or more than one server computing device. The server computing device 312 generates a shortened network address 322 corresponding to the web page 308, whereas the server computing device 314 generates an image representation 330 of a portion of the web page 308 and that is accessible via the shortened network address 322.

More specifically, the server computing device 312 includes a processor 316 and a computer-readable data storage medium 318. Likewise, the server computing device 314 includes a processor 324 and a computer-readable data storage medium 326. The server computing devices 312 and 314 can and typically do include other components, in addition to processors and computer-readable data storage media. The computer-readable data storage medium 326 can be or include volatile and/or non-volatile media like semiconductor memory, hard disk drives, and the like.

The computer-readable data storage medium 318 of the server computing device 312 stores a computer program 320 that the processor 316 executes to generate the shortened network address 322. The computer-readable data storage medium 318 of the server computing device 314 stores a computer program 328 that the processor 324 executes to generate the image representation 330 of a portion of the web page 308. As such, the computer program 320 implements parts 110, 112, and 114 of the method 100. By comparison, the computer program 328 implements parts 122, 124, and 126 of the method 100.

We claim:

1. A non-transitory computer-readable data storage medium storing one or more computer programs executable by a processor of a computing system to perform a method (100) comprising:
receiving a network address of a web page from a client computing device (106);
generating a shortened network address corresponding to the web page (110);
returning the shortened network address to the client computing device (112); and
generating an image representation of a portion of the web page, as one or more image files (124),
wherein the shortened network address is linked to the image representation of the portion of the web page.

2. The non-transitory computer-readable data storage medium of claim 1, wherein the client computing device is a first computing device, and the method further comprises:
receiving a request from a second client computing device via the shortened network address (122); and
in response to receiving the request from the second client computing device via the shortened network address, transmitting to the second client computing device the one or more image files of the image representation of the portion of the web page (126).

3. The non-transitory computer-readable data storage medium of claim 2, wherein generating the image representation of the portion of the web page is performed in response to receiving request from the second client computing device via the shortened network address, after receiving the request from the second client computing device via the shortened network address,
and wherein the image representation of the portion of the web page is generated dynamically based on one or more characteristics of the second client computing device, including one or more of a physical screen size and a screen resolution of the second client computing device,
such that client computing devices having different characteristics receive different image representations of the portion of the web page responsive to sending the same shortened network address.

4. The non-transitory computer-readable data storage medium of claim 3, wherein the one or more image files comprise a plurality of image files where the one or more characteristics of the second client computing device are such that the second client computing device is unlikely to be able to efficiently render the image representation of the portion of the web page as just a single image file, as judged in accordance with a predetermined criterion.

5. The non-transitory computer-readable data storage medium of claim 3, wherein the one or more image files comprise a single image file where the one or more characteristics of the second client computing device are such that the second client computing device is likely to be able to efficiently render the image representation of the portion of the web as the single image file, as judged in accordance with a predetermined criterion.

6. The non-transitory computer-readable data storage medium of claim 2, wherein the first and second computing devices are one of: the same client computing device, and different client computing devices.

7. The non-transitory computer-readable data storage medium of claim 2, wherein the image representation of the portion of the web page includes an embedded link to the network address of the web page,
such that clicking on any part of the image representation of the portion of the web page at and as rendered on the second computing device causes the second computing device to browse to the web page at the network address.

8. The non-transitory computer-readable data storage medium of claim 1, wherein the portion of the web page does not include an entirety of the web page and is a primary and most relevant portion of the web page as determined in accordance with a predetermined criterion.

9. The non-transitory computer-readable data storage medium of claim 1, wherein the web page includes one or more of text, images, and actively and dynamically generated content, whereas the image representation includes just the one or more image files and represents a static version in image form of the one or more of the text, the images, and the actively and dynamically generated content of the web page.

10. A computing system (300/106) comprising:
one or more server computing devices (312, 314); and,
a computer-readable data storage medium (318, 326) storing one or more computer programs (320, 318) performed by the one or more server computing devices to generate as one or more image files an image representation of a portion of a web page accessible at a network address, the image representation accessible at a shortened network address.

11. The computing system of claim 10, wherein the one or more computer programs are further performed by the one or more server computing devices to receive the network address from a client computing device and to return the shortened network address to the client computing device.

12. The computing system of claim 10, wherein the one or more computer programs are further performed by the one or more server computing devices to receive a request from a client computing device via the shortened network address, and in response to transmit the one or more image files of the image representation of the portion of the web page,
wherein the one or more image files are generated in response to receiving the request from the client computing device via the shortened network address, after receiving the request from the client computing device via the shortened network address, and dynamically based on one or more characteristics of the client computing device, including one or more of a physical screen size and a screen resolution of the client computing device.

13. The computing system of claim 10, wherein the image representation of the portion of the web page includes an embedded link to the web page,
such that clicking on any part of the image representation of the portion of the web page at and as rendered on the computing device causes the computing device to browse to the web page.

14. A method (100) comprising:
transmitting a network address of a web page by a first client computing device to a computing system (108);
in response to receiving the network address, generating by the computing system a shortened network address corresponding to the web page and returning the shortened network address to the first client computing device (112, 114);
transmitting a request via the shortened network address by a second client computing device to the computing system (120);
in response to receiving the request, generating by the computing system an image representation of a portion of the web page as one or more image files, and transmitting the one or more image files to the second client computing device (124, 126); and
rendering and displaying the image representation by the second client computing device upon receiving the one or more image files from the computing system (128).

15. The method of claim 14, wherein the image representation of the portion of the web page includes an embedded link to the web page,
and wherein the method further comprises clicking on any part of the image representation of the portion of the web page at and as rendered on the second client computing device to cause the second computing device to browse to the web page (130).
